(19) United States
(12) Patent Application Publication
(10) Pub. No.: US 2014/0050584 A1
(43) Pub. Date: Feb. 20, 2014

(54) COMBINATION PADDLE AND FISHING ROD

(71) Applicant: David Bradley Lange, Tavernier, FL (US)

(72) Inventor: David Bradley Lange, Tavernier, FL (US)

(21) Appl. No.: 13/968,899

(22) Filed: Aug. 16, 2013

Related U.S. Application Data
(60) Provisional application No. 61/684,112, filed on Aug. 16, 2012.

(51) Int. Cl. B63H 16/04; A01K 87/06

(52) U.S. Cl. CPC B63H 16/04; A01K 87/06
USPC 416/146 R; 43/22

(57) ABSTRACT

A device and system for propelling a watercraft through water and for fishing. The device includes a shaft that defines a first opening. A blade is coupled to a first end of the shaft, and a handle is coupled to a second end, the handle defining a second opening. A passage is in fluid communication with both the first opening and the second opening. The device may further include an extension element defining a third opening and being slidably disposed within the shaft, movable from a retracted configuration to an extended configuration. The system includes the device and fishing reel releasably engaged with the reel seat. Line from the reel enters the first opening, passes through the shaft, and exits from the second opening. With an extension element, line passes from the reel into the first opening, through the shaft and the extension element, and out the third opening.

### CROSS-REFERENCE TO RELATED APPLICATION

This application is related to and claims priority from U.S. Provisional Patent Application Ser. No. 61/684,112, filed Aug. 16, 2012, entitled PADDLE FISHING ROD, the entirety of which is incorporated herein by reference.

### STATEMENT REGARDING FEDERALLY SPONSORED RESEARCH OR DEVELOPMENT

n/a

### FIELD OF THE INVENTION

The present invention relates to water sports equipment, and more particularly, to a device having the functionality of a watercraft paddle and the functionality of a fishing rod.

### BACKGROUND OF THE INVENTION

Fishing rods and watercraft paddles are well known. Although each is well suited for its particular purpose, no known fishing rods are usable as paddle and no known paddles are usable as fishing rods. Further, no know devices are usable for both purposes in a safe an effective manner.

Stand-up paddleboarding is becoming an increasingly popular sport, and many people fish from their boards with a fishing rod. For example, one company manufactures stand-up paddleboards with a removable back rest that can be used to hold a fishing rod while the user is paddling the board, and to hold the paddle when the user stops paddling to fish with the fishing rod. However, having both a fishing rod and paddle on a paddleboard is cumbersome, and a user can easily lose his or her balance while swapping the paddle for the fishing rod and vice versa. Further, if the user needs to relocate the board during fishing or needs to paddle the board against the direction in which a hooked fish is swimming, the necessity for the user to manipulate both a fishing rod and a paddle makes the task nearly impossible.

Additionally, for most fishing rods, the fishing line is exposed. That is, the fishing line extends along an external surface of the rod, making the line vulnerable to snags and breakage. Further, the exposed line may easily become entangled with the user, the watercraft, and/or other equipment during use. Some known devices include a standard fishing rod to which a detachable blade may be coupled at the handle end of the fishing rod. However, these standard fishing rods are not rigid enough to be used effectively as a paddle. Additionally, the fishing line is exposed, thereby posing the same problems as noted above. Finally, although some fishing rods are known wherein the fishing line travels through the interior of the rod for a distance, these poles are useless for propelling a watercraft through the water.

Therefore, it is desirable to provide a device that is usable as both a fishing rod and a paddle. It is further desirable to provide a device that includes paddle and fishing rod functionality in a safe and effective manner.

### SUMMARY OF THE INVENTION

The present invention advantageously provides a device and system for propelling a watercraft through water and for fishing. In one embodiment, the device may include an elongate shaft including a wall, a first end, a second end, and a passage therebetween, the shaft wall defining a first opening; a blade coupled to and closing the first end of the shaft; a handle coupled to the second end, the handle including a head portion, the head portion defining a second opening, the first opening being between the blade and the handle, the passage being in fluid communication with both the first opening and the second opening; and a fishing reel coupling element disposed on the shaft proximate the first opening. The device may further include a fishing reel releasably engaged with the fishing reel coupling element, wherein the fishing reel includes fishing line, the fishing line passing from the fishing reel and entering into the first opening, passing through the passage, and exiting from the second opening. The device may further include at least one fishing line guide disposed on the shaft between the fishing reel coupling element and the first opening. The device may further include an elongate extension element slidably disposed within the passage of the shaft. Further, the second opening may be sized to accommodate the extension element therethrough. The extension element may be longitudinally movable within the passage between a first configuration in which the extension element is disposed entirely within the device and a second configuration in which at least a portion of the extension element is extended distally from the handle. Further, the extension element may include a proximal portion, a distal portion, a passage therebetween, and a third opening located at the distal portion, and may be more flexible than the shaft. When an extension element is used, the fishing line may pass from the fishing reel and entering into the first opening, pass through the shaft passage and the extension element passage, and exit from the third opening in the extension element. The fishing line may be disposed within the device for the entire distance between the first opening and the third opening. Additionally, the handle may define a funnel tapering into a passage, the passage extending from the funnel to the second opening.

In another embodiment, a paddle configured to propel a watercraft through water and configured for fishing may include an elongate shaft including a longitudinal axis, a wall, a first end, a second end, and a first passage therebetween, the shaft wall defining an opening that is substantially orthogonal to the longitudinal axis; a blade coupled to the first end; a handle coupled to the second end, the handle including a head portion, the head portion defining a second opening that is substantially coaxial with the longitudinal axis, the first opening being between the blade and the handle, the first passage being in fluid communication with both the first opening and the second opening; an elongate extension element slidably disposed within the first passage, the elongate extension element defining a first end, a second end, a second passage therebetween, and a third opening located at the second end, the third opening being substantially coaxial with the longitudinal axis and being in fluid communication with the first passage; and a fishing reel coupling element disposed on the shaft proximate the first opening. The paddle may further include a fishing reel releasably engaged with the fishing reel coupling element, wherein the fishing reel includes fishing line, the fishing line passing from the fishing reel and entering into the first opening, passing through the first passage, passing through the second passage, and exiting from the third opening. Further, the fishing line may be disposed within the device for the entire distance between the first opening and the third opening. The extension element may be longitudinally movable within the passage between a first configuration in which the extension element is disposed entirely within the device and a second configuration in which at least a portion of the extension element is extended distally from the handle.

In another embodiment, a fishing rod system may include an elongate shaft including a longitudinal axis, a wall, a butt end, a tip end, and a first passage therebetween, the shaft wall defining an opening that is substantially orthogonal to the longitudinal axis; a flattened component at the butt end, the flattened component having length and a width, and having a greater surface area than a length of the shaft that is equal to the length of the flattened component; a handle coupled to the tip end, the handle including a head portion, the head portion defining a second opening that is substantially coaxial with the longitudinal axis, the first opening being between the blade and the handle, the first passage being in fluid communication with both the first opening and the second opening; an elongate extension element slidably disposed within the first passage, the elongate extension element defining a proximal end, a distal end, a second passage therebetween, and a third opening located at the distal end, the third opening being substantially coaxial with the longitudinal axis and being in fluid communication with the first passage; and a fishing reel seat disposed on the shaft proximate the first opening. The system may further include a fishing reel releasably engaged with the fishing reel seat, wherein the fishing reel includes fishing line, the fishing line passing from the fishing reel and entering into the first opening, passing through the first passage, passing through the second passage, and exiting from the third opening. The fishing line may be disposed within the device for the entire distance between the first opening and the third opening. Further, the extension element may be more flexible than the shaft. The extension element may be longitudinally movable within the passage between a first configuration in which the extension element is disposed entirely within the device and a second configuration in which at least a portion of the extension element is extended distally from the handle.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 shows a first embodiment of a combination paddle and fishing rod including a conventional fishing reel and extension tip;

FIG. 2 shows a second embodiment of a combination paddle and fishing rod including a spinning reel and not including an extension tip;

FIG. 3 shows a close-up view of the shaft of a combination paddle and fishing rod including a first embodiment of a reel seat;

FIG. 4 shows a close-up view of the shaft of a combination paddle and fishing rod including a second embodiment of a reel seat;

FIG. 5 shows a partial view of a shaft of a combination paddle and fishing rod, including a fishing line guide, a first opening in the shaft, and a second opening in the handle;

FIG. 6 shows a distal end of a combination paddle and fishing rod including an extension tip in a retracted configuration;

FIG. 7 shows a distal end of the combination paddle and fishing rod of FIG. 5, the extension tip being in an extended configuration;

FIG. 8 shows a cross-sectional view of an extension tip within the combination paddle and fishing rod of FIGS. 5 and 6;

FIGS. 9 and 10 show a schematic view of a first embodiment of an adjustment mechanism for an extension tip;

FIGS. 11 and 12 shows a schematic view of a second embodiment of an adjustment mechanism for an extension tip;

FIG. 13 shows a close-up view of a handle assembly for a combination paddle and fishing rod;

FIGS. 14-17 show a combination paddle and fishing rod in an exemplary use;

FIG. 18 shows an alternative embodiment of a combination paddle and fishing rod including two blades; and

FIG. 19 shows a combination paddle and fishing rod including two blades and an extension tip.

### DETAILED DESCRIPTION OF THE INVENTION

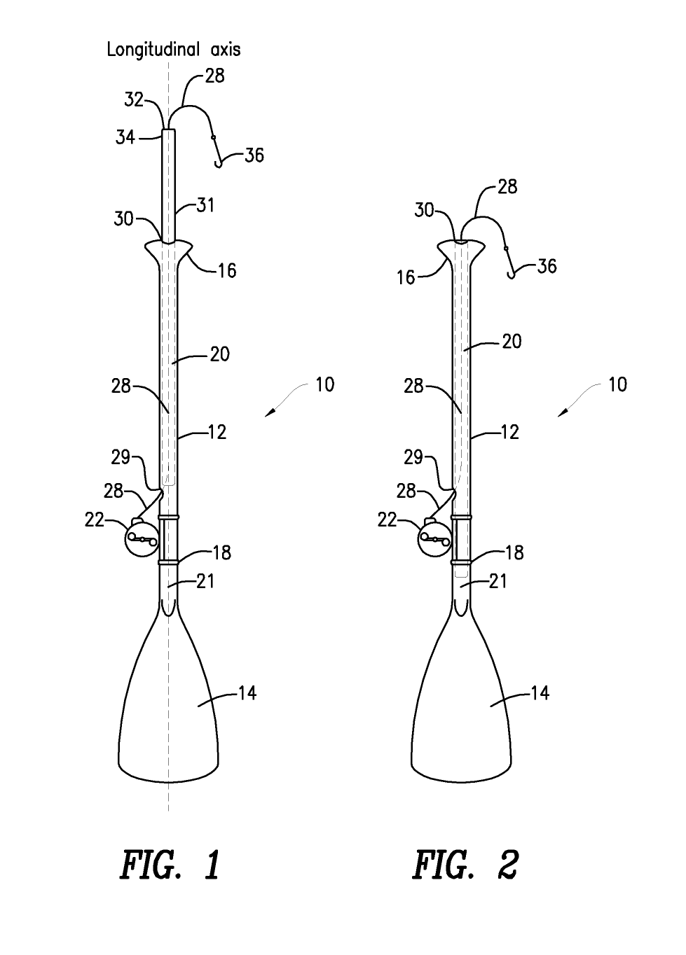

Referring now to FIGS. 1 and 2, a combination paddle and fishing rod including a fishing reel is shown. It will be understood that even though the device 10 is referred to as a paddle, the term may refer to any means for moving water that includes a shaft 12 with a blade 14 at one or both ends. The primary purpose of the device 10 may be to act as a paddle for propulsion of a craft in the water. To that end, the paddle 10 may also include a handle 16 and a reel seat 18 (also referred to as a reel coupling element). Generally, the shaft 12 is grasped by a user and the blade 14 is dipped into the water from a watercraft (for example, a boat or board, such as a stand-up paddleboard) to propel the watercraft. The blade 14 may generally be a flattened portion providing increased surface area in order to move a larger volume of water. That is, over the same length value, the blade 14 may have a greater surface area than the shaft 12. Although the blade 14 is described as generally being flattened, it may also have curvature, raised areas, and/or irregular surface patterns. Typically, the user may place one hand on the handle 16 and the other hand at a location along the shaft 12. For some applications, the shaft 12 may be composed of a material such as aluminum, carbon fiber, fiberglass, wood, plastic, or other suitable material, and may have a combination of stiffness for strength and flex for distributing energy from the user to the blade 14. The shaft 12 may be tubular shape having a passage 20 within. Further, the shaft may be bent, straight, or have another suitable configuration. Although the primary purpose of the device 10 may be to act as a paddle for propulsion of a craft in the water, the device 10 may also be used for fishing. If analogized to a fishing pole rather than to a paddle, the device blade 14 would be located at the handle or butt end and the device handle 16 would be located at the rod tip end.

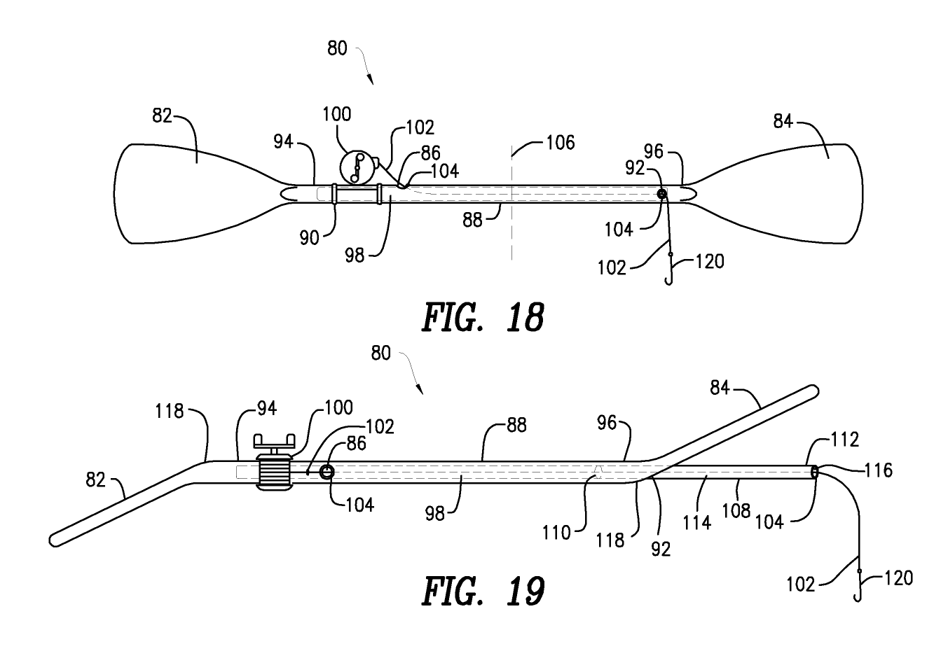

The blade 14 may be any size or shape suitable for a particular application and/or user. For example, a paddle used for canoeing may have a larger surface area than a paddle used for stand-up paddleboarding. Additionally, a paddle may be used that includes two blades 14, one at either end of the shaft (as shown in FIG. 18). When a single blade 14 is used, the blade 14 may be referred to as being coupled to or integrated with a first end 21 of the shaft 12. The blade length, blade width, blade symmetry, feather or angle between the blades (such as when using a paddle with two blades), and other factors may also be selected according to the particular application and/or user. The blade may be flat, curved, or have another suitable configuration.

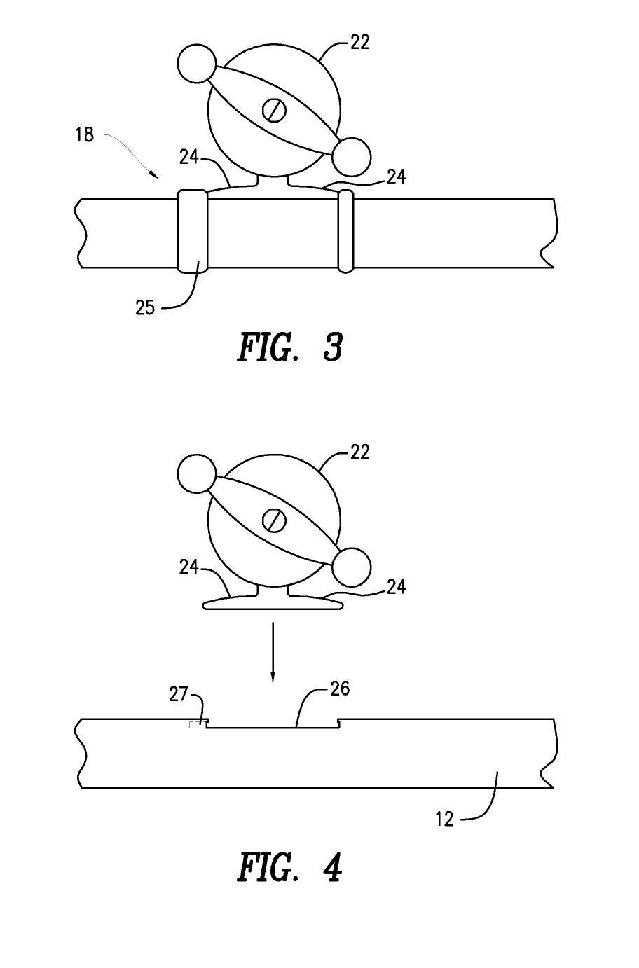

Referring now to FIGS. 3 and 4, close-up views of the shaft 12 of a combination paddle and fishing rod including a reel seat 18 is shown. The reel seat 18 may be located on the shaft 12 to removably attach a fishing reel 22 to the paddle 10. The reel seat 18 may be a universal reel seat 18 usable for a typical fishing rod and with any of a variety of reel types. As a non-limiting example, the reel 22 may be a conventional fishing reel (as shown in FIG. 1), a spinning reel (as shown in FIG. 2), spin cast reel, underspin reel, on the like. The reel 22 may be releasably engageable with the reel seat 18 in a known manner. For example, the reel seat 18 may include one or more threaded rings 25 that are slidable over and secures a reel foot 24 onto the shaft 12. Further, the reel seat 18 may be permanently or removably affixed to the shaft 12. Alternatively, the shaft 12 may include an indentation 26 in which to set the reel 22. The indentation 26 may include a slot 27 in which to engage one reel foot 24, from where the other reel foot 24 may be secured to the shaft 12 using other means, such as rope, tape wrap, cable ties, string, straps, or other suitable means. If not permanently affixed to the shaft 12, the reel seat 18 may be configured such that its position on the shaft 12 may be adjustable. However, even if the reel seat 18 position is adjustable, the reel seat 18 will be located somewhere between the blade 14 and the first opening 29.

It will be understood that the placement of a reel 22 on any of a variety of shafts 12 may be shifted according to the needs and/or personal preferences of the user. In most cases, however, the reel 22 may be placed at a location that is a distance from the location at which the user's hands engage the shaft 12 during paddling. The position of the reel 22 could vary by craft and/or by user and should be addressed considering the comfort of the user, safety, and maintenance of the reel 22. Typically, however, the reel 22 may be mounted on the shaft 12 proximate the blade 14.

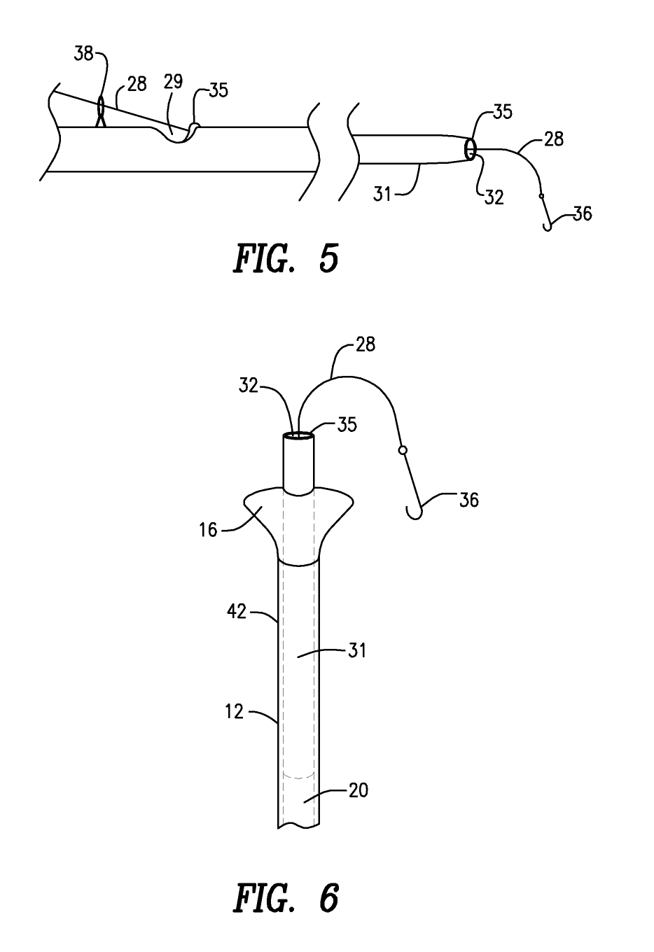

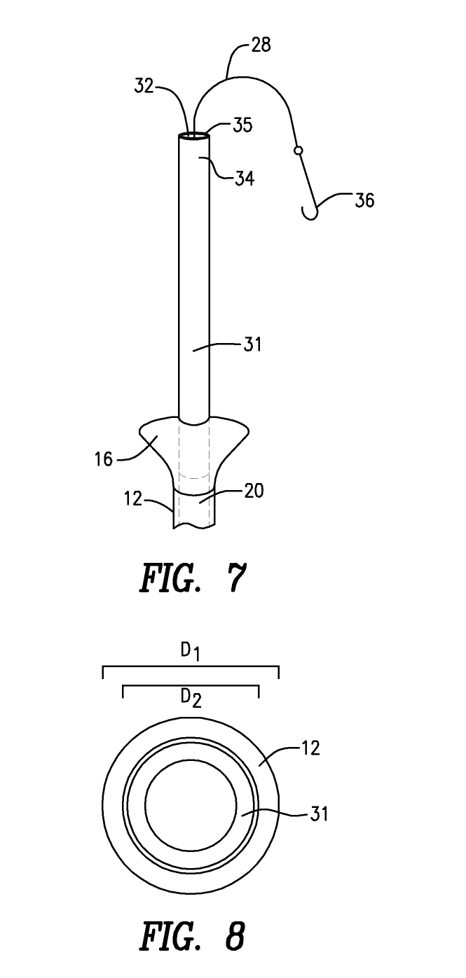

The fishing line 28 may be passed from the reel 22, through a first opening 29 on the shaft 12, into the passage 20 of the shaft 12, and through a second opening 30 from where the fishing line 28 exits the paddle 10. Alternatively, if an extension tip 31 is used (for example, as shown in FIG. 1), the fishing line may exit a third opening 32 located at the distal end of the extension element. The first opening 29 may define an entrance that is substantially orthogonal to the longitudinal axis of the paddle 10, whereas the second 30 and third 32 openings may each define an entrance that is substantially coaxial to the longitudinal axis of the paddle 10. Further, the first 29 and second 30 openings may be defined by the shaft 12 wall, and the third opening 32 may be defined by the extension tip 36 wall. The openings 29, 30, 32 may each include a smooth bushing 35 to reduce friction between the paddle 10 and the fishing line 28. Various items of bait and/or tackle 36, such as weights, lures, live bait, spoons, jigs, and the like may be attached to the free end of the fishing line 28. Additionally, one or more weights may be affixed to the free end of the fishing line 28 before the line 28 enters the shaft to facilitate passing the line 28 through the passage 20 and out the second opening 30. The proximal opening 29 may be located on the shaft 12 proximate the reel 22. For example, the proximal opening 29 may be located between approximately 3 inches and approximately 20 inches distal of the reel 22. The distal opening 30 may be located in the handle 16 (as shown in FIGS. 1 and 2) or in the distal portion of an extension tip 31 (as shown in FIGS. 6 and 7). As is shown in FIGS. 1 and 2, the fishing line 28 passes along at least a portion of the length of the shaft 12, preferably a majority of the length of the shaft, within the passage 20. As a non-limiting example, the line 28 may be disposed within the shaft for a distance that is between approximately 50% and approximately 95% of the length of the shaft 12. However, the line 28 may be disposed within the shaft 12 for the entire distance between the first opening 29 and the second opening 30. When the extension tip 31 is used, as a non-limiting example, the line 28 may be disposed within the shaft 12 and extension tip 31 for a distance that is between approximately 50% and approximately 95% of the length of the shaft 12. However, the line 28 may be disposed within the shaft 12 for the entire distance between the first opening 29 and the third opening 32. If the line 28 were allowed to pass from the reel 22 to the handle 16 or extension tip 31 on the outside of the shaft 12, the line 28 may interfere with the ability to effectively use the device 10 as a paddle or may compromise user safety by risking entanglement of the line 28 and the user.

Referring now to FIG. 5, a partial view of a shaft of a combination paddle and fishing rod, including a fishing line guide 38, a first opening 29 in the shaft 12, and a second opening 30 in the handle 16 is shown. A third opening 32 may also be included in a distal end 34 of the extension tip 31. A bushing 35 may be included on at least a portion of each of the openings 29, 30, 32. For example, the bushing 35 may be disposed about the entire lip of the opening 29, 30, 32 (as shown in FIG. 5 on the third opening 30), or only on the portion of the lip of the opening into which the line 28 comes in contact (as shown in FIG. 5 on the first opening 29). The bushings 35 may be composed of a material such as brass, graphite, plastic, or other hard, friction-reducing material.

The paddle 10 may further include one or more fishing line guides 38, such as those commonly used on fishing rods. The one or more fishing line guides 38 may assist in the delivery of fishing line 28 from the reel 22 to the abrasion-resistant bushing 35 and into the passage 20 of the shaft 12. The one or more fishing line guides 38 may be useful when, for example, combined with a spinning reel 22 that tends to whip the line 28 in a circular motion when casting or retrieving the line 28. The one or more fishing line guides 38 may be located between the reel 22 and the first opening 29 in the shaft 12 to guide the line 28 into the first opening 29 and reduce line chafing that can lead to premature wear and breakage of the line 28.

Referring now to FIGS. 6-8, a second end 42 of a combination paddle and fishing rod including an extension tip 31 is shown. The extension tip 31 may be slidably disposed within the passage 20 of the shaft 12, such that the extension tip 31 may be advanced to an extended configuration 44 (as shown in FIG. 7), retracted to a retracted configuration 46 (as shown in FIG. 6), or otherwise moved longitudinally within the passage to a configuration between the extended 44 and retracted 46 configurations. As such, the diameter (D₂) of the extension tip 31 is less than the diameter (D₁) of the shaft 12 (as shown in FIG. 8). Although a small gap is shown between the wall of the shaft 12 and the wall of the extension tip 31, in some embodiments the wall of the extension tip 31 may be in contact with the wall of the shaft 12. As shown in FIG. 7, the extension tip 31 may extend from the passage 20 of the shaft 12 through the handle 16, such that the handle 16 remains affixed to the shaft 12. Further, the extension tip 31 may be solid or hollow and may be composed of a material and/or have a wall thickness that imparts on the extension tip 31 a flexibility characteristic that is greater than the flexibility characteristic of the shaft 12. For example, the extension tip 31 may be configured similar to the distal section of a conventional light- to medium-action fishing rod. Further, the flexibility, configuration, and length of the extension tip 31 may complement the size of the reel 22, strength of the line 28, and/or the animal for which the user is fishing. The extension tip 31 may be tubular or tapered to a point.

When the paddle 10 is in use, the extension tip 31 may be advanced to the extended configuration 44. This may keep the fishing line 28 away from the user's hands at the handle 16, and also may keep the extended line 28 from striking or becoming entangled with, for example, the user's face, head, hat, or ears. For example, a user may make a cast and leave the bait and/or tackle 36 dragging in the water a distance behind the watercraft, similar to trolling. The user may still then paddle with the line 28 well above his or her head, safely out of the way. Additionally, as the extension tip 31 may be more flexible than the shaft 12 (for example, by virtue of being composed of a more flexible material and/or having a smaller diameter), the extension tip 31 may provide increased flexibility and sensitivity when fishing. A flexible tip may enable the user to feel a fish bite and to more gently fight a hooked fish.

When the user is not fishing or when the paddle 10 is being stored or transported, the extension tip 31 may be retracted inside the passage 20 of the shaft 12. This may protect the extension tip 31 from damage and may facilitate storing and/or transporting the paddle 10. When transitioning the paddle 10 for fishing, the extension tip 31 may be manually pulled to extend from the shaft 12 by a suitable distance.

It will be understood that an extension tip 31 may not be preferred for all situations. For example, if the shaft 12 is particularly long, such as when used for certain stand-up paddleboards, the length of the shaft 12 may be sufficient to meet the user's needs without the extension tip 31 (as shown in FIG. 2).

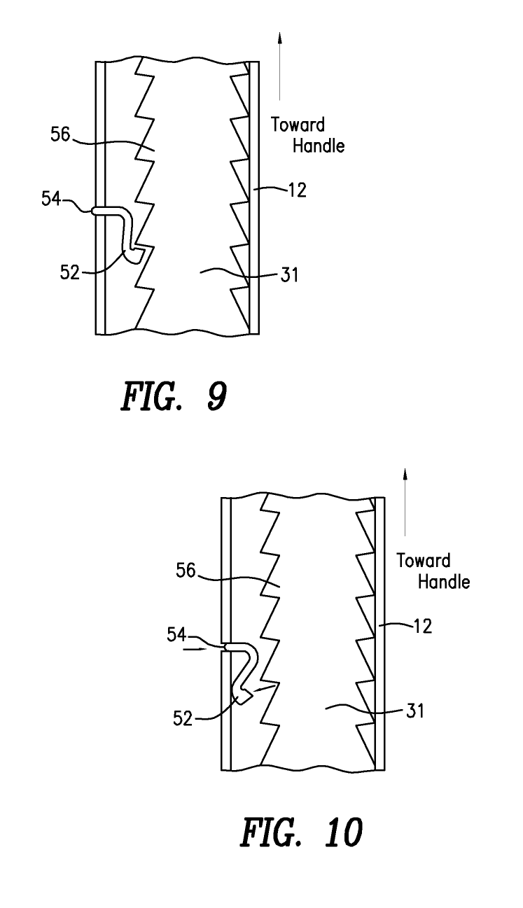

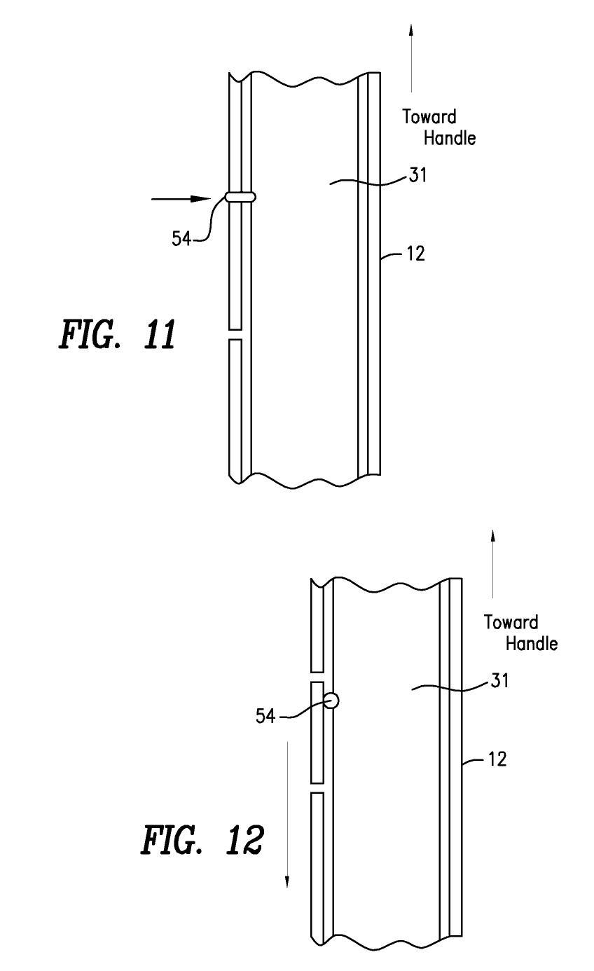

Referring now to FIGS. 9-12, a first embodiment and a second embodiment of an adjustment mechanism 48 for the extension tip 31 are shown. An adjustment mechanism 48 may allow the extension tip 31 to be securably extended to any distance between the fully retracted configuration and the fully extended configuration. The extension tip 31 may be frictionally engaged passage 20 of the shaft 12 or the second opening 30 in the handle 16. Additionally or alternatively, the extension tip 31 may be engageable with the passage 20 by a ratchet mechanism 52 with release button 54 (as shown in the schematic view of FIGS. 9 and 10). For example, the user may freely slide the extension tip 31 to extend it distally, with the ratchet mechanism engaging with a series of teeth 56 disposed on an outer surface of the extension tip 31 to prevent the extension tip 31 from retracting within the shaft 12. Pushing the release button 54 may disengage the ratchet mechanism 52 from the teeth 56 to allow free longitudinal movement of the extension tip 31 within the shaft 12 in either direction. Alternatively, the extension tip 31 may be engageable with the passage 20 by a push-button locking mechanism (as shown in FIGS. 11 and 12). For example, the shaft 12 may include one or more openings 58 sized to receive a push button 60 integrated with the extension tip 31. A user may push the push button 60 inward to disengage the push button 60 from an opening 58 to allow for free longitudinal movement of the extension tip 31 within the shaft in either direction. The push button 60 will re-extend outward when it encounters an opening 58, thereby releasably locking the extension tip 31 in place. The distance the extension tip 31 extends from the shaft 12 may be determined by the location of the opening 58 with which the push button 60 is engaged.

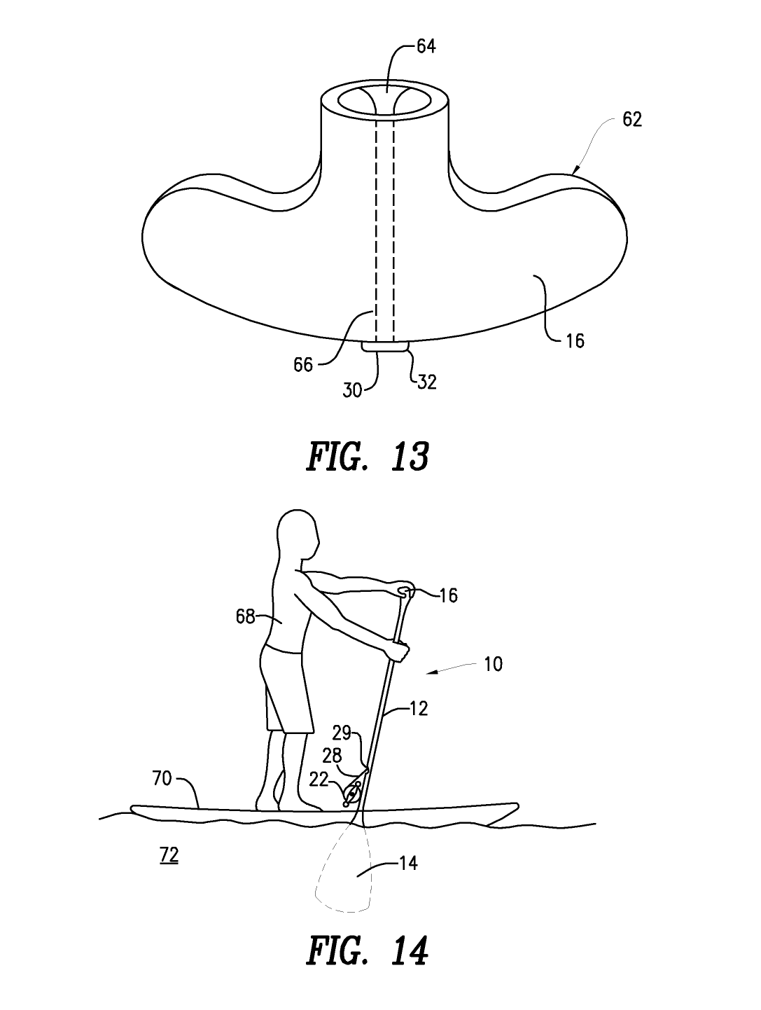

Referring now to FIG. 13, a close-up view of a handle assembly 62 for a combination paddle and fishing rod is shown. The handle assembly 62 may be used when the paddle 10 does not include an extension tip 31. The handle assembly 62 may generally include a handle 16, a funnel 64 defined by the handle 16, a bore or passage 66 defined by the handle 16, and a bushing 35. The funnel 64 may help to guide the fishing line 28 from the passage 20 out of the second opening 30 of the paddle 10. In the embodiment of FIG. 13, the second opening 30 is in the head portion (or grip portion) of the handle 16. Thus, the handle 16 does not need to be removed from the shaft 12 in order to thread fishing line 28 through the paddle 10. The second opening 30 may have a smaller diameter in paddles 10 that do not include an extension tip 36. Conversely, paddles 10 that do include an extension tip 36 may have a second opening 30 with a larger diameter, the diameter being sufficient to accommodate the diameter of the extension tip 36. The handle assembly 62 may be permanently affixed to or integrated with the shaft (for example, using an adhesive or bonding agent, or manufacturing the shaft and handle as a single piece). Alternatively, the handle 16 may be releasably engageable with the shaft 12. For example, the handle 16 may include a threaded portion for rotationally engagement with a threaded portion on second end 42 of the shaft 12, or the handle 16 may include a snap engagement matable with the second end 42 of the shaft 12 (not shown). Additionally or alternative to the funnel 64, a flexible threading rod (not shown) may also be used to guide the fishing line 28 through the passage 20 and out the second opening 30. The handle 16 may have any size or shape, such as a palm-grip or T-grip handle.

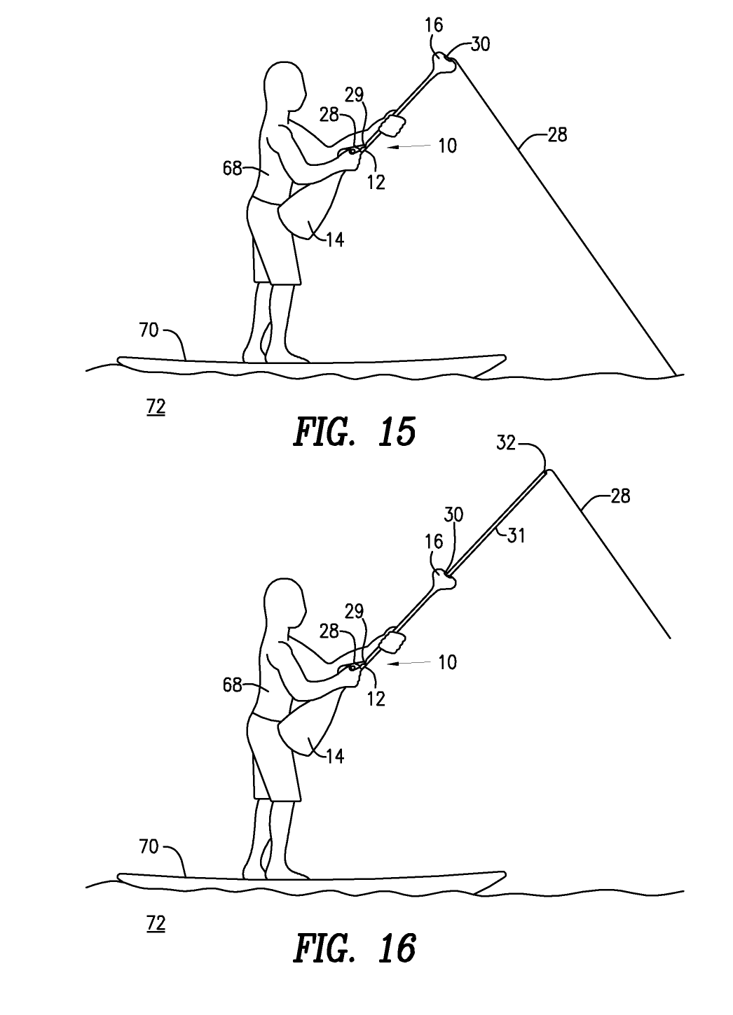

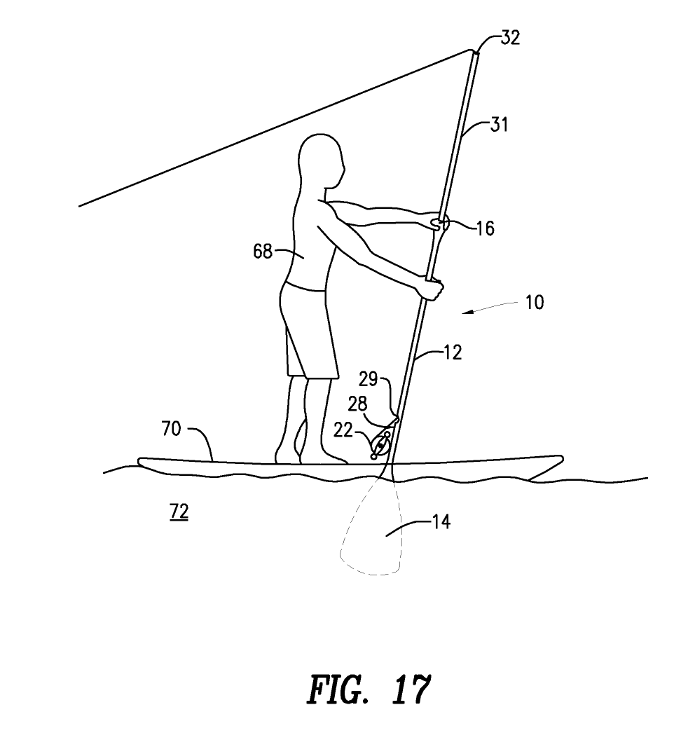

Referring now to FIGS. 14-17, a combination paddle and fishing rod is shown in an exemplary use. In the non-limiting example shown in FIG. 14, the user 68 may use the paddle to propel a stand-up paddleboard 70 through the water 72. The paddle 10 shown in FIG. 14 may include an extension tip 31 that is in the retracted configuration 46 or the paddle 10 may not include an extension tip 31. In the non-limiting examples shown in FIGS. 15 and 16, the user 68 may use the paddle 10 for fishing. The paddle 10 may include an extended extension tip 31 (as shown in FIG. 16) or the paddle may not include an extension tip 31 (as shown in FIG. 15). Further, the user 68 may use the paddle 10 for both propulsion of the stand-up paddleboard 70 through the water 72 and for fishing. For example, the user 68 may grasp the handle 16 with one hand and the shaft 12 with the other hand, and the fishing line 28 may extend from the third opening 32 in the extension tip 31 (as shown in FIG. 17). As described above, the extension tip 31 may keep the exposed line 28 away from the user 68. When fishing, the user may hold the paddle 10 in any way that is comfortable and convenient. For example, the user may anchor the blade 14 of the paddle 10 between the user's torso and one arm.

Referring now to FIG. 18, an alternative embodiment of a combination paddle and fishing rod is shown, the device 80 having two blades 82, 84. The embodiment of FIG. 18 may be used for watersports such as kayaking, rafting, or the like. The blades 82, 84 of the double-bladed paddle 80 may be inline (that is, the faces of the blades being coplanar), feathered (that is, the faces of the blades lying in different planes), or adjustable between being inline and feathered. As in the single-bladed embodiment, the double-bladed paddle 80 of FIG. 18 includes a first opening 86 defined by the shaft 88 wall proximate a first blade 82, a reel seat 90 on the shaft 88 proximate the first opening 86, and a second opening 92. The first blade 82 may be coupled to or integrated with a first end 94 of the shaft 88. The paddle 80 may also include a second blade 84 that may be coupled to or integrated with a second end 96 of the shaft 88. The second opening 92 may be defined by the shaft 88 wall at a location proximate the second blade 84, or it may be defined by the shaft 88 wall at a location between the first opening 86 and the second blade 84. The second opening 92 may lie in the same radial direction from the longitudinal axis of the paddle 80 as the first opening 86, or it may lie in a different radial direction (as shown in FIG. 18). The openings 86, 92 may be defined by the shaft 88 wall. Further, the shaft 88 may define a passage 98 between the first end 94 and the second end 96.

As shown and described in FIGS. 1-17, any of a variety of fishing reels 100 may be removably attached to the fishing reel seat 90. Also as shown and described in FIGS. 1-17, fishing line 102 may pass from the reel 100 and enter into the first opening 86, pass through the passage 98, and exit from the second opening 92. The first 86 and second 92 openings may each include a bushing as shown and described in FIGS. 1-17 to reduce friction between the lip of the opening and the fishing line.

The paddle 80 may be bisected by an imaginary center line 106. When paddling, the user may grasp the shaft 88 of the paddle 80 with a first hand at a location on one side of the centerline 106, and may grasp the shaft 88 of the paddle 80 with a second hand at a location on the opposite side of the centerline 106. Exactly where the user places his or her hands may be a matter of preference. The reel seat 90 may be configured to be adjustable along the length of the shaft 88, so that a user may adjust the position of the reel 100 to ensure the reel 100 is not located where the user would comfortably place his or her hand. However, even if the reel seat 90 position is adjustable, the reel seat 90 will be located somewhere between the first blade 82 and the first opening 86.

Referring now to FIG. 19, a combination paddle and fishing rod is shown, the paddle 80 including two blades 82, 84 and an extension tip 108 slidably disposed within the passage 98 of the shaft 88. The extension tip 108 may be as shown scribed in FIGS. 1-17, having a proximal end 110, a distal end 112, a passage 114 extending therethrough, and a third opening 116 in the distal end 112. The passage 114 of the extension tip 108 may be in fluid communication with the first opening 86, the shaft passage 98, and the second opening 92. Further, the passage 98 of the extension tip 108 may be coaxial with the passage 98 of the shaft 88. The extension tip 108 may be slidably disposed within the shaft passage 98, such that it may be longitudinal moved between a first retracted configuration and a second extended configuration (as shown in FIG. 19). The extension tip 108 position may be locked in place using, for example, a frictional fit with the passage 98 and the second opening 92, or an adjustment mechanism such as those shown and described in FIGS. 9-12. Paddles 80 that include an extension tip 108 may be bent 118 at the interface between the shaft 88 and the blades 82, 84, so that the extension tip 108 may extend in substantially a straight line from the shaft 88 without interference from the second blade 84. Further, in embodiments using an extension tip 108, the second opening 92 may be defined by the shaft 88 wall at or near the bend 118, and the diameter of the second opening 92 may be greater than the diameter of the second opening 92 in non-extension tip embodiments, in order to accommodate the diameter of the extension tip 108. Bait and/or tackle (for example, weights, lures, spoons, jigs, hooks, and the like) 120 may be attached to the free end of the fishing line 102.

It will be appreciated by persons skilled in the art that the present invention is not limited to what has been particularly shown and described herein above. In addition, unless mention was made above to the contrary, it should be noted that all of the accompanying drawings are not to scale. A variety of modifications, combinations of features, and variations are possible in light of the above teachings without departing from the scope and spirit of the invention, which is limited only by the following claims.

What is claimed is:

1. A device for both propulsion through water and for fishing, the device comprising:
an elongate shaft including a wall, a first end, a second end, and a passage therebetween, the shaft wall defining a first opening;
a blade coupled to and closing the first end of the shaft;
a handle coupled to the second end, the handle including a head portion, the head portion defining a second opening, the first opening being between the blade and the handle, the passage being in fluid communication with both the first opening and the second opening; and
a fishing reel coupling element disposed on the shaft proximate the first opening.

2. The device of claim 1, further comprising a fishing reel releasably engaged with the fishing reel coupling element, wherein the fishing reel includes fishing line, the fishing line passing from the fishing reel and entering into the first opening, passing through the passage, and exiting from the second opening.

3. The device of claim 1, further comprising at least one fishing line guide disposed on the shaft between the fishing reel coupling element and the first opening.

4. The device of claim 1, wherein the device further comprises an elongate extension element slidably disposed within the passage of the shaft.

5. The device of claim 4, wherein the second opening is sized to accommodate the extension element therethrough.

6. The device of claim 5, wherein the extension element is longitudinally movable within the passage between a first configuration in which the extension element is disposed entirely within the device and a second configuration in which at least a portion of the extension element is extended distally from the handle.

7. The device of claim 6, wherein the extension element includes a proximal portion, a distal portion, a passage therebetween, and a third opening located at the distal portion.

8. The device of claim 7, wherein the extension element is more flexible than the shaft.

9. The device of claim 7, further comprising a fishing reel releasably engaged with the fishing reel coupling element, wherein the fishing reel includes fishing line, the fishing line passing from the fishing reel and entering into the first opening, passing through the shaft passage and the extension element passage, and exiting from the third opening in the extension element.

10. The device of claim 9, wherein the fishing line is disposed within the device for the entire distance between the first opening and the third opening.

11. The device of claim 2, wherein the handle defines a funnel tapering into a passage, the passage extending from the funnel to the second opening.

12. A paddle configured to propel a watercraft through water and configured for fishing, the paddle comprising:
an elongate shaft including a longitudinal axis, a wall, a first end, a second end, and a first passage therebetween, the shaft wall defining an opening that is substantially orthogonal to the longitudinal axis;
a blade coupled to the first end;
a handle coupled to the second end, the handle including a head portion, the head portion defining a second opening that is substantially coaxial with the longitudinal axis, the first opening being between the blade and the handle, the first passage being in fluid communication with both the first opening and the second opening;
an elongate extension element slidably disposed within the first passage, the elongate extension element defining a first end, a second end, a second passage therebetween, and a third opening located at the second end, the third opening being substantially coaxial with the longitudinal axis and being in fluid communication with the first passage; and
a fishing reel coupling element disposed on the shaft proximate the first opening.

13. The paddle of claim 12, further comprising a fishing reel releasably engaged with the fishing reel coupling element, wherein the fishing reel includes fishing line, the fishing line passing from the fishing reel and entering into the first opening, passing through the first passage, passing through the second passage, and exiting from the third opening.

14. The device of claim 13, wherein the fishing line is disposed within the device for the entire distance between the first opening and the third opening.

15. The device of claim 12, wherein the extension element is longitudinally movable within the passage between a first configuration in which the extension element is disposed entirely within the device and a second configuration in which at least a portion of the extension element is extended distally from the handle.

16. A fishing rod system comprising:
an elongate shaft including a longitudinal axis, a wall, a butt end, a tip end, and a first passage therebetween, the shaft wall defining an opening that is substantially orthogonal to the longitudinal axis;
a flattened component at the butt end, the flattened component having length and a width, and having a greater surface area than a length of the shaft that is equal to the length of the flattened component;
a handle coupled to the tip end, the handle including a head portion, the head portion defining a second opening that is substantially coaxial with the longitudinal axis, the first opening being between the blade and the handle, the first passage being in fluid communication with both the first opening and the second opening;
an elongate extension element slidably disposed within the first passage, the elongate extension element defining a proximal end, a distal end, a second passage therebetween, and a third opening located at the distal end, the third opening being substantially coaxial with the longitudinal axis and being in fluid communication with the first passage; and
a fishing reel seat disposed on the shaft proximate the first opening.

17. The system of claim 16, further comprising a fishing reel releasably engaged with the fishing reel seat, wherein the fishing reel includes fishing line, the fishing line passing from the fishing reel and entering into the first opening, passing through the first passage, passing through the second passage, and exiting from the third opening.

18. The system of claim 17, wherein the fishing line is disposed within the device for the entire distance between the first opening and the third opening.

19. The system of claim 16, wherein the extension element is more flexible than the shaft.

20. The system of claim 16, wherein the extension element is longitudinally movable within the passage between a first configuration in which the extension element is disposed entirely within the device and a second configuration in which at least a portion of the extension element is extended distally from the handle.
